(19) United States
(12) Patent Application Publication
(10) Pub. No.: US 2006/0015656 A1
(43) Pub. Date: Jan. 19, 2006

(54) Retrieval of configuration information from information processing apparatus

(75) Inventor: Katsutoshi Hayashi, Kawasaki-shi (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KAWASAKI-SHI (JP)

(21) Appl. No.: 11/175,292

(22) Filed: Jul. 7, 2005

(30) Foreign Application Priority Data
Jul. 14, 2004 (JP) 2004-207097

(51) Int. Cl. G06F 3/00

(52) U.S. Cl. 710/8

(57) ABSTRACT

An information processing apparatus includes a nonvolatile memory incorporated in the information processing apparatus, a recording medium removably disposed in the information processing apparatus, and an information manger for managing information stored in the nonvolatile memory and the recording medium. When the information manager registers configuration information, which is inherent in the information processing apparatus of its own, for operating an OS, an application, data, or an expansion driver, in the nonvolatile memory, the information manger also registers the configuration information in the recording medium.

### BACKGROUND OF THE INVENTION

1. Field of the Invention

The present invention relates to an information processing apparatus which utilizes an OS (Operating System) and applications.

2. Description of the Related Art

Portable information processing apparatus such as cellular phones or the like which utilize an OS and applications have a registry for storing such inherent configuration information as information as to operating environments for operating the OS and the applications, and information as to actual operating states of the OS and the applications. The configurational information is registered in a RAM (Random Access Memory) in the information processing apparatus. The configuration information in the RAM is erased when the information processing apparatus is turned off or reset.

In order to avoid the risk of the erasure of the configuration information from the RAM when the information processing apparatus is turned off or reset, there has been proposed an information processing apparatus which register configuration information also in a nonvolatile memory such as FROM (Flash Read Only Memory) in the information processing apparatus. For details, reference should be made to Japanese laid-open patent publication

However, if the disclosed information processing apparatus fails to operate, then the configuration information registered in the nonvolatile memory cannot be retrieved. When another information processing apparatus is used as a substitute for the malfunctioning information processing apparatus, it is necessary to store the configuration information again in the other information processing apparatus. Therefore, when an information processing apparatus malfunctions and its operation is interrupted, a substituting information processing apparatus cannot immediately be put into operation because of the need for registering the configuration information therein prior to its operation.

### SUMMARY OF THE INVENTION

It is therefore an object of the present invention to provide an information processing apparatus which allows configuration information registered therein to be retrieved in the event of a failure of the information processing apparatus.

According to the present invention, there is provided an information processing apparatus for registering and managing configuration information inherent therein for operating an OS, an application, data, or an expansion driver.

The information processing apparatus includes a nonvolatile memory incorporated in the information processing apparatus, a recording medium removably disposed in the information processing apparatus, and an information manger for registering the configuration information in the recording medium when the configuration information is registered in the nonvolatile memory.

With the above arrangement, since the configuration information is registered in not only the nonvolatile memory, but also the removable recording medium, even if the information processing apparatus malfunctions, the configuration information of the malfunctioning information processing apparatus can be retrieved through the recording medium.

When the recording medium having registered therein configuration information of another information processing apparatus is loaded, the information manager may read the configuration information of the other information processing apparatus from the recording medium.

With the above arrangement, when an information processing apparatus malfunctions, the recording medium may be removed from the malfunctioning information processing apparatus and may be loaded into another information processing apparatus, so that the other information processing apparatus can read and utilize the configuration information of the malfunctioning information processing apparatus.

When the recording medium having registered therein configuration information of another information processing apparatus is loaded, the information manager may read the configuration information of the other information processing apparatus from the recording medium, and may register the configuration information in the nonvolatile memory.

With the above arrangement, when an information processing apparatus malfunctions, the recording medium may be removed from the malfunctioning information processing apparatus and may be loaded into another information processing apparatus, so that the same configuration information as that of the malfunctioning information processing apparatus can be registered in the other information processing apparatus. In addition to registering configuration information of a malfunctioning information processing apparatus, it is also possible to register configuration information of an information processing apparatus as initial configuration information of another information processing apparatus.

When the recording medium having registered therein configuration information of another information processing apparatus and the application, the data, or the expansion driver is loaded, the information manager may read the configuration information of the other information processing apparatus and also may read the application, the data, or the expansion driver from the recording medium.

With the above arrangement, when an information processing apparatus malfunctions, the recording medium may be removed from the malfunctioning information processing apparatus and may be loaded into another information processing apparatus, so that the other information processing apparatus can restore the operating state of the application, etc. immediately prior to the failure of the information processing apparatus, and can continuously take over the operation of the malfunctioning information processing apparatus.

Specifically, the configuration information includes information as to operating environments for operating the OS, the application, the data, or the expansion driver, and information as to actual operating states of the OS, the application, the data, or the expansion driver.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of an information processing apparatus according to an embodiment of the present invention; and

FIG. 2 is a block diagram showing the manner in which configuration information is retrieved from the information processing apparatus shown in FIG. 1.

### DESCRIPTION OF THE PREFERRED EMBODIMENT

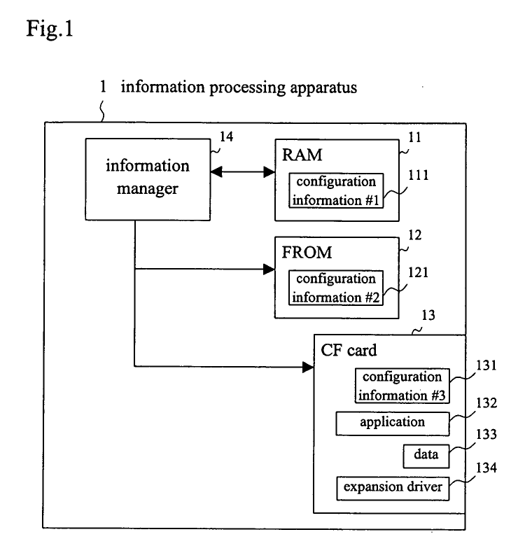

As shown in FIG. 1, information processing apparatus 1 according to an embodiment of the present invention comprises RAM 11 incorporated therein, FROM 12 as a nonvolatile memory incorporated therein, CF (Compact Flash) card 13 as a removable recording medium removably disposed therein, and information manager 14 for managing information stored in RAM 11, ROM 12, and CF card 13.

Information manager 14 registers inherent configuration information for operating application 132, data 133, and expansion driver 134 that are registered in CF card 13 and operating an OS (not shown), as configuration information (#1) 111 in RAM 11. Specifically, the configuration information is information as to operating environments for operating the OS, application 132, data 133, and expansion driver 134, and information as to actual operating states of the OS, application 132, data 133, and expansion driver 134.

Information manager 14 also registers configuration information (#1) 111 stored in RAM 11 as configuration information (#2) 121 in FROM 12 and also registers configuration information (#1) 111 as configuration information (#3) 131 in CF card 13.

In information processing apparatus 1, therefore, the same configuration information is dually registered as configuration information (#2) 121 and configuration information (#3) 131 in respective two storage areas, i.e., an area in FROM 12 and an area in CF card 13. The configuration information can be retrieved through CF card 13.

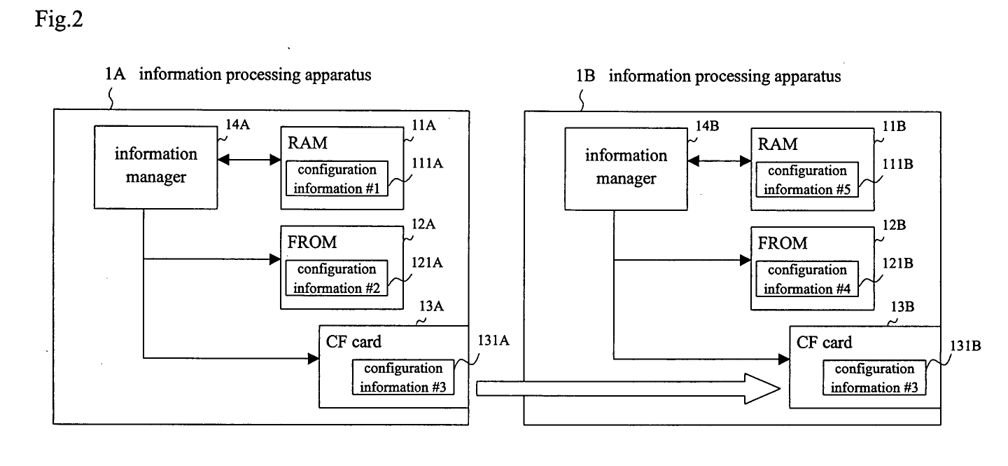

Operation of information processing apparatus 1 according to the present embodiment will be described below with reference to FIG. 2.

FIG. 2 shows two information processing apparatus 1A, 1B according to the present embodiment. Information processing apparatus 1A, 1B have respective RAMs 11A, 11B, respective FROMs 12A, 12B, respective CF cards 13A, 13B, and respective information managers 14A, 14B, which correspond to RAM 11, FROM 12, CF card 13, and information manager 14, respectively, shown in FIG. 1.

First, information processing apparatus 1A operates to register configuration information for operating an OS and applications. Specifically, information manager 14A registers the configuration information as configuration information (#1) 111A in RAM 111A. Then, information manager 14A registers configuration information (#1) 111A stored in RAM 11A as configuration information (#2) 121A in FROM 12A. Configuration information (#1) 111A and configuration information (#2) 121A are identical to each other. Furthermore, information manager 14A registers configuration information (#1) 111A stored in RAM 11A as configuration information (#3) 131A in CF card 13A. Configuration information (#1) 111A, configuration information (#2) 121A, and configuration information (#3) 131A are identical to each other. FROM 12A stores two pieces of configuration information, i.e., the configuration information that is presently registered and the configuration information that is previously registered. Even if the process of registering configuration information (#1) 111A as configuration information (#2) 121A in FROM 12A fails, since the previously registered configuration information remains as configuration information (#2) 121A in FROM 12A, the present configuration information can be registered again based on previously registered configuration information (#2) 121A in FROM 12A.

The above process of registering configuration information in information processing apparatus 1A can be manually set by the user from a menu that is registered in the operating system (OS).

Then, the user removes CF card 13A from information processing apparatus 1A, and loads CF card 13A as CF card 13B into information processing apparatus 1B. CF card 13A and CF card 13B are identical to each other. Therefore, configuration information (#3) 131A stored in CF card 13A and configuration information (#3) 131B stored in CF card 13B are identical to each other.

For information processing apparatus 1B to use configuration information (#3) 131B stored in CF card 13B from the OS and the applications, information processing apparatus 1B operates to reflect (restore) the configuration information. Specifically, information manager 14B reads configuration information (#3) 131B stored in CF card 13B, and registers configuration information (#3) 131B as configuration information (#4) 121B in FROM 12B. Configuration information (#3) 131B and configuration information (#4) 121B are identical to each other. Furthermore, information manager 14B registers configuration information (#3) 131B stored in CF card 13B as configuration information (#5) 111B in RAM 11B. Configuration information (#3) 131B, configuration information (#4) 121B, and configuration information (#5) 111B are identical to each other.

Though not shown, CF card 13A also stores application 132, data 133, and expansion driver 134 registered therein in addition to configuration information (#3) 131A (see FIG. 1). Therefore, information manager 14B also reads application 132, data 133, and expansion driver 134 registered in CF card 13A.

As described above, CF card 13A removably mounted in information processing apparatus 1A is removed therefrom and loaded as CF card 13B into information processing apparatus 1B, and configuration information (#3) 131A, application 132, etc. registered in CF card 13A are reflected in information processing apparatus 1B. Consequently, application 132 and data 133 which were used by information processing apparatus 1A while it was in operation can continuously be used in information processing apparatus 1B.

Even if information processing apparatus 1A suffers a malfunction in its operation, the user may remove CF card 13A from information processing apparatus 1A and load CF card 13B into information processing apparatus 1B, so that information processing apparatus 1B can restore the operation of application 132 and data 133 immediately prior to the failure of information processing apparatus 1A, and can continuously take over the operation of information processing apparatus 1A.

Information processing apparatus 1A, 1B are not limited to usage in the above application wherein the operation of malfunctioning information processing apparatus 1A is continuously taken over by information processing apparatus 1B. However, information processing apparatus 1A, 1B may be used in an application wherein when information processing apparatus 1B starts to operate, the same operating environments as in information processing apparatus 1A are initially set in information processing apparatus 1B. As described above, information processing apparatus 1A can register operating environments represented by an OS and applications as configuration information in CF card 13A as a removable recording medium. Therefore, the same operating environments as in information processing apparatus 1A can initially be set easily in information processing apparatus 1B. Furthermore, when a plurality of information processing apparatus start to operate, the same operating environments as in information processing apparatus 1A can initially be set easily in those information processing apparatus by using copies of CF card 13A.

Information processing apparatus 1A according to the present invention may not only have configuration information registered manually by the user from the operating system (OS) menu, but may have configuration information registered automatically in synchronism by the operating system (OS). However, when information manager 14A registers configuration information (#1) 111 as configuration information (#2) 121A in FROM 12A and simultaneously registers configuration information (#1) 111 as configuration information (#3) 131A in CF card 13A, a writing error may possibly occur. Therefore, information manager 14A needs to register configuration information (#3) 131A in CF card 13A after it has completed the registration of configuration information (#2) 121A in FROM 12A.

Each of information processing apparatus 1A, 1B according to the present invention may use not only a CF card, but also any of various removable recording mediums such as an SD (Secure Digital) card, a PC card, a memory stick, etc. as a removable recording medium for retrieving configuration information.

Each of information processing apparatus 1A, 1B according to the present invention is applicable to not only portable information processing apparatus such as a cellular phone, but also stationary information processing apparatus such as a PC. The principles of the present invention are applicable to any information processing apparatus which are energized by a power supply, and are not limited to cell-powered information processing apparatus.

While preferred embodiments of the present invention have been described using specific terms, such description is for illustrative purposes only, and it is to be understood that changes and variations may be made without departing from the spirit or scope of the following claims.

What is claimed is:

1. An information processing apparatus for registering and managing configuration information inherent therein for operating an OS, an application, data, or an expansion driver, comprising:
a nonvolatile memory incorporated in the information processing apparatus;
a recording medium removably disposed in the information processing apparatus; and
an information manger for registering said configuration information in said recording medium when said configuration information is registered in said nonvolatile memory.

2. An information processing apparatus according to claim 1, wherein when said recording medium having registered therein configuration information of another information processing apparatus is loaded, said information manager reads the configuration information of the other information processing apparatus from said recording medium.

3. An information processing apparatus according to claim 1, wherein when said recording medium having registered therein configuration information of another information processing apparatus is loaded, said information manager reads the configuration information of the other information processing apparatus from said recording medium, and registers the configuration information in said nonvolatile memory.

4. An information processing apparatus according to claim 1, wherein said configuration information includes information as to operating environments for operating said OS, said application, said data, or said expansion driver, and information as to actual operating states of said OS, said application, said data, or said expansion driver.

5. An information processing apparatus according to claim 1, wherein said recording medium registers said application, said data, or said expansion driver, together with said configuration information.

6. An information processing apparatus according to claim 5, wherein when said recording medium having registered therein configuration information of another information processing apparatus and said application, said data, or said expansion driver is loaded, said information manager reads the configuration information of the other information processing apparatus and also reads said application, said data, or said expansion driver from said recording medium.
